(19) United States
(12) Patent Application Publication
(10) Pub. No.: US 2015/0214624 A1
(43) Pub. Date: Jul. 30, 2015

(54) MICRO BASE STATION ANTENNA

(71) Applicant: Electronics and Telecommunications Research Institute, Daejeon (KR)

(72) Inventors: Heon Kook KWON, Daejeon (KR); Jung Nam LEE, Daejeon (KR); Byung Su KANG, Daejeon (KR); Jung Hoon OH, Daejeon (KR); Kwangchun LEE, Daejeon (KR)

(73) Assignee: Electronics and Telecommunications Research Institute, Daejeon (KR)

(21) Appl. No.: 14/596,367

(22) Filed: Jan. 14, 2015

(30) Foreign Application Priority Data
Jan. 28, 2014 (KR) 10-2014-0010207

(51) Int. Cl. H01Q 9/04; H01Q 1/38; H01Q 1/52; H04B 1/04

(52) U.S. Cl. CPC H01Q 9/0407; H04B 1/04; H01Q 1/38; H01Q 1/52; H04W 88/08

(57) ABSTRACT

Provided is a micro base station antenna including a substrate etched with first and second micro strip lines, a first inverted F antenna, a second inverted F antenna facing the first inverted F antenna, and an isolator provided between the first inverted F antenna and the second inverted F antenna. According to the present invention, a micro base station antenna that has a wide bandwidth, a high gain, and an enhanced isolation characteristic can be provided.

### CROSS-REFERENCE TO RELATED APPLICATIONS

This U.S. non-provisional patent application claims priority under 35 U.S.C. §119 of Korean Patent Application No. 10-2014-0010207, filed on Jan. 28, 2014, the entire contents of which are hereby incorporated by reference.

### BACKGROUND OF THE INVENTION

The present invention disclosed herein relates to an antenna, and more particularly, to a micro base station antenna that includes two inverted F antennas.

A mobile communication technology has been switched from analog communication to digital communication and the technology has then evolved into 2 G, 3 G, and 4 G. In particular, 3.9 G service that is represented by LTE and WiMAX is being currently employed across the world. In addition to an evolving communication technology, as smart devices such as high-performance smart phones and tablets are widely distributed and a demand for a massive-data service such as a high-definition image service explosively increases, there is a trend toward remarkably growing mobile communication traffic.

As techniques for maximizing the transmission speed and capacity of data with limited frequency resources, there are an active antenna technique, an MIMO technique, and a beam-forming technique. However, it is true that the development speed of a technology does not keep up with the increase speed of mobile traffic. A solution to solve rapidly increasing mobile traffic with limited frequency resources includes increasing the number of base stations. Increasing the number of mobile communication base stations involves limitations in that spaces and costs for installation and costs for maintaining and repairing base stations increase. Also, there is also a drawback in that switching to a new service to be developed in the future is difficult.

The next-generation mobile communication base station system is based on the current system, satisfies a demand for exponentially increasing mobile traffic and may cope quickly with a new communication system to be developed in the future. A typical mobile communication base station system has a structure in which a radio frequency unit (RFU), a base band unit (BBU), and a transport layer are located at one cabinet and connected to a transmission and reception antenna by using a coaxial line However, the mobile communication base station has developed to a distributed base station which connects, a centralized station where a plurality of digital units are gathered, to a radio unit called a remote radio unit (RRU), by using an optical line. The next-generation mobile communication base station has a structure in which an RF unit is separated from a base band unit, they are connected by using an optical line and a decreased RF unit is integrated into an antenna mechanism.

In order to decrease the RF unit in such a next-generation mobile communication base station system, there is a need to decrease the antenna. Decreasing the antenna that is a unit occupying the largest volume among single RF units is very important. In the case of a currently developed antenna for a base station, since the size of the antenna is very large and the antenna is an array antenna that includes a number of antennas in one mechanism, the antenna is inappropriate for using as the next-generation mobile communication base station. In particular, since the 800 MHz band called a gold frequency is low, it is very difficult to decrease a size and to expand a bandwidth. Also, since the next-generation mobile communication base station system has a structure in which the RF unit and the antenna are mounted in one micro cube, there is a need to develop a micro antenna for a base station.

### SUMMARY OF THE INVENTION

The present invention provides a micro base station antenna that has a wide bandwidth, a high gain, and an enhanced isolation characteristic.

Embodiments of the present invention provide a micro base station antennas including: a substrate etched with first and second micro strip lines, the substrate being provided in a cube; a first inverted F antenna including a first metallic short-circuit plate provided on the first micro strip line and a first radiation patch provided on the first metallic short-circuit plate; a second inverted F antenna including a second metallic short-circuit plate provided on the second micro strip line and a second radiation patch provided on the second metallic short-circuit plate, the second inverted F antenna facing the first inverted F antenna; and an isolator provided between the first inverted F antenna and the second inverted F antenna.

In some embodiments, the isolator may include a third metallic short-circuit plate provided on the substrate and a metallic isolating plate provided on the third metallic short-circuit plate.

In other embodiments, the first and second micro strip lines may include first and second power supply lines and first and second short-circuit lines, respectively.

In still other embodiments, the micro antennas may further include a ground plane provided between the cube and the substrate, wherein the ground plane may not be provided on a part where the first and second radiation patches overlap the ground plane.

In even other embodiments, the first and second power supply lines may be connected to first and second SMA connectors respectively through via holes, wherein the via holes may be formed by passing through the substrate, the ground plane, and the cube.

In yet other embodiments, the first and second short-circuit lines may be connected to the ground plane through the via holes formed by passing through the substrate.

In further embodiments, the third short-circuit plate may be connected to the ground plane through the via hole formed by passing through the substrate.

In still further embodiments, the first and second radiation patches may be quadrilateral or circular.

In even further embodiments, the metallic isolating plate may be quadrilateral or circular.

In yet further embodiments, the cube may be a metallic component formed of aluminum Al or copper Cu.

In much further embodiments, the cube may be a non-metallic component formed of polycarbonate, acetal, Teflon, or silicon.

In still much further embodiments, one surface of the cube being in contact with the ground plane may be a square, wherein one side of the square has a length smaller than or equal to half an operation frequency.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 shows a micro base station antenna according to an embodiment of the present invention;

FIG. 2 shows an example of a substrate and antennas configuring a micro base station antenna according to an embodiment of the present invention;

FIG. 3 is a cross-sectional view taken along line I-I′ of FIG. 1;

FIG. 4 is a cross-sectional view taken along line II-II′ of FIG. 1;

FIG. 5 is a graph showing a return loss and an isolation characteristic when there is no isolator;

FIG. 6 is a graph showing a return loss and an isolation characteristic when there is an isolator;

FIG. 7 is a graph showing the radiation pattern of a micro base station antenna according to an embodiment of the present invention;

FIG. 8 is a graph showing a return loss depending on the width of a radiator in a micro base station antenna according to an embodiment of the present invention;

FIG. 9 is a graph showing a return loss depending on the length of a radiator in a micro base station antenna according to an embodiment of the present invention;

FIG. 10 is a graph showing an isolation characteristic depending on the width of a metallic isolating plate in a micro base station antenna according to an embodiment of the present invention; and

FIG. 11 is a graph showing an isolation characteristic depending on the length of a metallic isolating plate in a micro base station antenna according to an embodiment of the present invention.

### DETAILED DESCRIPTION OF PREFERRED EMBODIMENTS

It should be understood that both the foregoing general description and the following detailed description are exemplary, and it should be appreciated that the additional description of the claimed invention is provided. Reference numerals are indicated in the exemplary embodiments of the present invention and their examples are indicated in the accompanying drawings. The same reference numerals are used in the description and drawings in order to refer to the same or similar parts wherever possible.

In the following, a dual polarization dipole antenna is uses as an example for explaining the characteristics and functions of the present invention. However, a person skilled in the art will be able to easily understand other advantages and performance of the present invention based on the details described herein. The present invention will be able to be implemented or applied through other embodiments. In addition, the detailed description may be modified or changed according to a viewpoint and an application without departing significantly from the scope, technical spirit and other purposes of the present invention.

Even though the terms a “first” and a “second” may be used for explaining various components, these components are not limited by these terms. The terms may only be used to distinguish one component from others. The term “include,” “comprise,” “including,” or “comprising,” used in the detailed description of the present invention specifies a characteristic, a step, an operation, an ingredient, and/or a component but does not exclude another or more characteristics, steps, operations, ingredients, components, and/or their groups. In the description of embodiments, it will be understood that when a layer is referred to as being “on/under” another layer or substrate, it can be directly on the other layer or substrate, or intervening layers may also be present. It will be understood that when an element or a layer is referred to as being “connected to”, “coupled to”, or “adjoining” another element or layer, it can be connected to, coupled to or adjoin the other layer directly, or intervening elements or layers may also be present.

Embodiments of the present invention are described below with reference to the accompanying drawings so that a person skilled in the art may easily practice the technical spirits of the present invention.

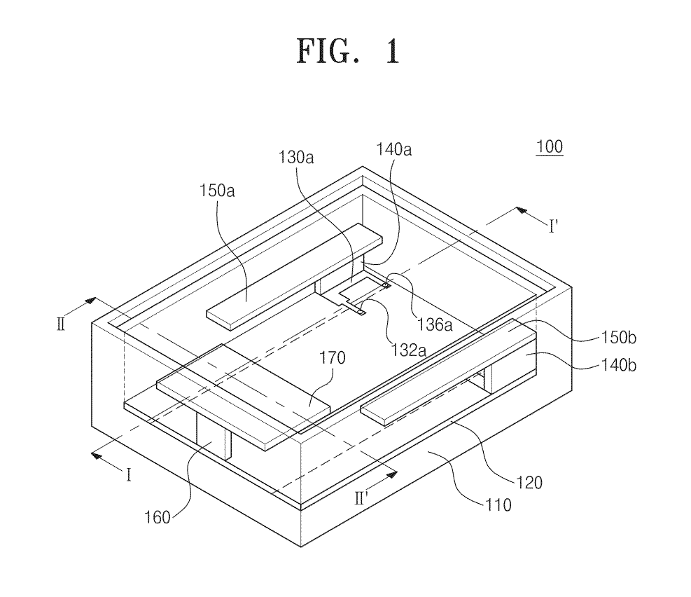

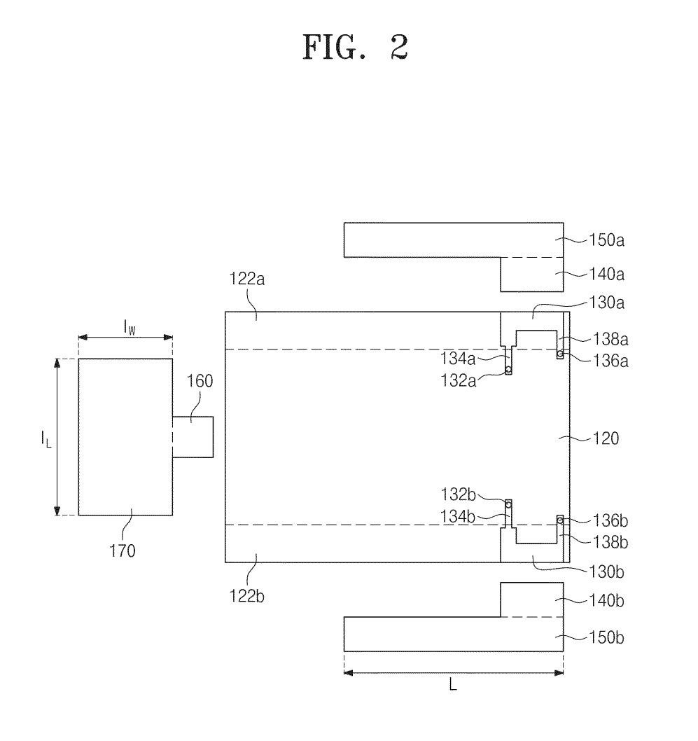

FIG. 1 shows a micro base station antenna according to an embodiment of the present invention. Referring to FIG. 1, a micro base station antenna 100 may include a cube 110, a substrate 120, a first micro strip line 130a, a second micro strip line 130b (see FIG. 2), first and second metallic short-circuit plates 140a and 140b, first and second radiation patches 150a and 150b, a third metallic short-circuit plate 160, and a metallic isolating plate 170.

The cube 110 is provided. The cube 110 may be provided in a cavity form to be able to surround a first inverted F antenna including the first metallic short-circuit plate 140a and the first radiation patch 150a and a second inverted F antenna including the second metallic short-circuit plate 140b and the second radiation patch 150b as a whole. In addition, each of the inverted F antennas may not be in contact with the internal side of the cube 110 although FIG. 1 shows that they are in contact therewith.

The length of one side of the cube 110 may be designed depending on an operation frequency. For example, when the cube 110 has a square form, the length of one side may be manufactured to have half a wavelength corresponding to the operation frequency. However, it may be manufactured to have quarter a wavelength in some embodiments but is not limited thereto. Also, the cube 110 may be manufactured in a circle. In this case, the diameter of the cube may be manufactured to have half or quarter a wavelength corresponding to the operation frequency. In addition, the cube 110 may be formed of a metallic material such as copper Cu or aluminum Al or a non-metallic material such as polycarbonate, acetal, plastic, silicon, or Teflon.

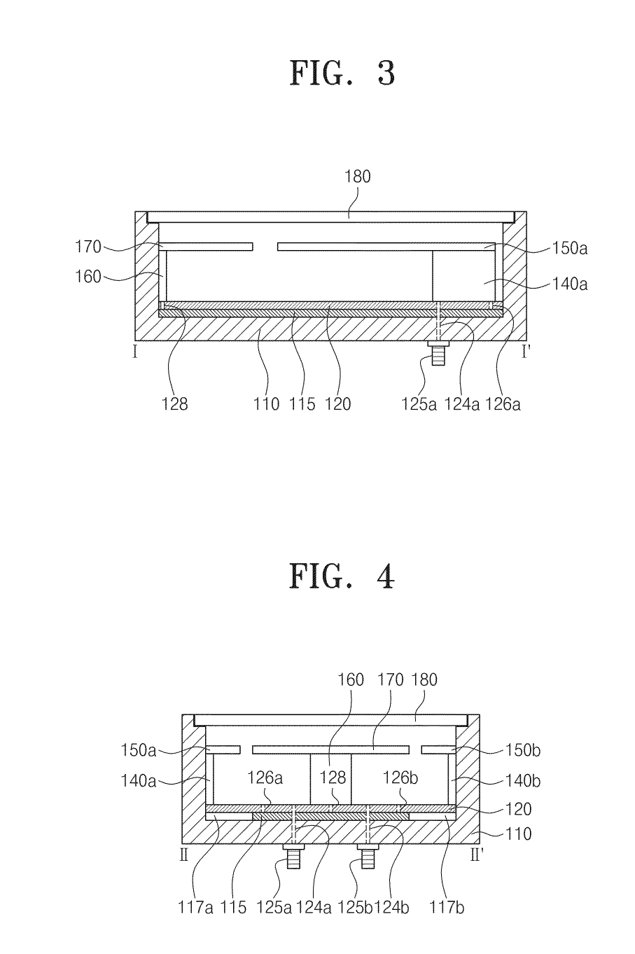

A ground plane 115 (see FIG. 3) is provided in the cube 110. The ground plane may be provided to ground the first to third metallic short-circuit plates 136a, 136b, and 160. According to an embodiment of the present invention, the ground plane may be provided in a part where the radiation patches 150a and 150b do not overlap the substrate 120. By arranging the ground plane as described above, it is possible to enhance the bandwidth of the antenna. Related descriptions are provided with reference to FIG. 3.

The substrate 120 is provided in the cube 110. For example, the substrate 120 may be formed of a dielectric substance having any permittivity and provided on the ground plane 115 (see FIG. 3).

The first and second micro strip lines 130a and 130b are provided on the substrate 120. For example, the first and second micro strip lines 130a and 130b may be etched on the substrate 120. The first micro strip line 130a may be provided to be in contact with one side of the cube 110 and the second micro strip line 130b may be provided to be in contact with the opposite side. However, when the cube 110 is formed of a metallic material, the first and second micro strip lines 130a and 130b may be etched not to be in contact with the cube 110. In addition, each of the micro strip lines may include power supply lines 134a and 134b and short-circuit lines 138a and 138b. SMA connectors 132a and 132b may be connected to ends of each of the power supply lines. In addition, each of the short-circuit lines 138a and 138b may be connected to the ground plane 115 (see FIG. 3) through via holes 136a and 136b that are provided on the ends of the short-circuit line.

The first and second metallic short-circuit plates 140a and 140b are provided on the first and second micro strip lines 130a and 130b. Each of the metallic short-circuit plates may be provided to be in contact with the internal side of the cube 110 perpendicularly to the substrate 120. Likewise, when the cube 110 is formed of a metallic material, the first and second metallic short-circuit plates 140a and 140b are arranged not to be in contact with internal side of the cube 110. The first and second metallic short-circuit plates 140a and 140b may be formed of a metallic material such as copper Cu, aluminum Al or the like.

The first and second radiation patches 150a and 150b are provided on the first and second metallic short-circuit plates 140a and 140b. Likewise, when the cube 110 is formed of a metallic material, the first and second radiation patterns 150a and 150b are arranged not to be in contact with internal side of the cube 110. The radiation patches 150a and 150b are mediums for receiving or transmitting electric waves and may be formed of a metallic material such as copper Cu, aluminum Al or the like.

Isolators 160 and 170 are provided. The isolators 160 and 170 may be provided between the first inverted F antenna and the second inverted F antenna in order to ensure the isolation between the two inverted F antennas. The isolators 160a and 170 may be arranged to be in contact with the internal side of the cube 110 but when the cube 110 is formed of a metallic material, they are arranged not to be in contact therewith. The isolators 160 and 170 may include the metallic isolating plate 170 and the third metallic short-circuit plate 160. The third metallic short-circuit plate 160 may be connected to the ground plane 115 (see FIG. 3) that may be provided between the cube 110 and the substrate 120 through a via hole provided in the substrate 120.

A radome 180 (see FIG. 3) is provided on the radiation patches 150a and 150b. The radome is provided to protect two inverted F antennas and may be an insulator.

According to an embodiment, in order to generate dual polarization, each of the first and second inverted F antennas may include the radiation patches 150a and 150b and the metallic short-circuit plates 140a and 140b that connect the radiation patches to the micro strip lines 130a and 130b. In addition, each of the micro strip lines includes the power supply lines 134a and 134b to which signals are applied by SMA connectors, and the short-circuit lines 136a and 136b connected to the ground plane 115 (see FIG. 3) provided under the substrate 120. In addition, the ground plane 115 (see FIG. 3) is provided under the substrate 120 on which antennas are placed, excluding a part where the radiation patterns 150a and 150b overlap the substrate 120, so it is possible to enhance the bandwidths of antennas. Also, by arranging the isolators 160 and 170 between the two inverted F antennas, it is possible to enhance the isolation between antennas. According to a micro antenna for a base station to which the antenna structure of the present invention is applied, it is possible to obtain a wide bandwidth, high isolation and gain even though it has a micro size.

FIG. 2 shows an example of a substrate and antennas configuring a micro base station antenna according to an embodiment of the present invention.

As shown in FIG. 2, the substrate 120 may include areas 122a and 122b that are indicated by broken lines. The areas include areas where the radiation patches 150a and 150b overlap the substrate on the micro base station antenna. Although FIG. 2 shows to be wider than overlapping areas, it will be understood that the areas may be variously set as long as including the overlapping areas. The ground plane 115 (see FIGS. 3 and 4) provided under the substrate 120 is provided excluding the areas 122a and 122b indicated by the broken lines. As such, by providing the ground plane 115 (see FIGS. 3 and 4) excluding the overlapping areas, there is an effect that may enhance the bandwidth of an antenna.

The first and second micro strip lines 130a and 130b are provided on the substrate 120. The micro strip lines may be etched to be symmetric to each other on the substrate 120 having any permittivity. However, the micro strip lines may not be symmetric to each other in some embodiments. In addition, each of the micro strip lines may be provided on the edge of the substrate 120 to be able to be in contact with one internal side of the cube 110 (see FIG. 1) and its opposite side. However, when the cube 110 is formed of a metallic material, the micro strip lines 130a and 130b should be etched not to be in contact with the metallic cube. In this case, each of the inverted F antennas and the isolator should also be arranged not to be in contact with the metallic cube. However, when the cube 110 is formed of a non-metallic material, the micro strip lines 130a and 130b, each of the inverted F antennas, and the isolator may also be arranged to be in contact with the non-metallic cube.

The micro strip lines 130a and 130b include the power supply lines 134a and 134b to which signals are applied, and the short-circuit lines 136a and 136b connected to the ground plane 115 (see FIG. 3) provided under the substrate 120, respectively. The power supply lines 134a and 134b are connected to the SMA connectors 132a and 132b, and the short-circuit lines 136a and 136b are connected to the ground plane 115 (see FIG. 3) through the via holes 136a and 136b provided to the substrate 120.

Referring to FIG. 2, the radiation patches 150a and 150b and the metallic short-circuit plates 150a and 150b may not be separated, namely may be integrated, and may make an angle of 90° to be provided perpendicularly to the substrate 120. Although FIG. 2 shows that the radiation patches and the metallic short-circuit plates are integrated, it will be well understood that they may be provided separately.

The isolators 160 and 170 are provided. The isolators 160 and 170 may be provided between the first inverted F antenna and the second inverted F antenna in order to ensure the isolation between the two inverted F antennas. The isolators may include the metallic isolating plate 170 and the third metallic short-circuit plate 160. The third metallic short-circuit plate 160 may be connected to the ground plane 115 (see FIG. 3) that is provided between the cube 110 and the substrate 120 through the via hole 128 provided in the substrate 120. Although FIG. 2 shows that the metallic isolating plate 170 has a rectangular shape, it will also be well understood that it may have various shapes such as circles in some embodiments.

Referring to FIG. 2, the metallic isolating plate 170 and the third metallic short-circuit plates 160 may not be separated, namely may be integrated, and may make an angle of 90° to be provided perpendicularly to the substrate 120. Although FIG. 2 shows that the metallic isolating plate 170 and the third metallic short-circuit plate 160 are integrated, it will be well understood that they may be provided separately.

FIG. 3 is a cross-sectional view taken along line I-I′ of FIG. 1. The first and second inverted F antennas are symmetric with respect to the line I-I′. However, as previously described, the two inverted F antennas may also be arranged not to be symmetric to each other.

Referring to FIG. 3, the cube 110 may be provided to surround the first inverted F antenna including the first metallic short-circuit plate 140a and the first radiation patch 150a and the second inverted F antenna (not shown), and the radome 180 may be provided to cover the inverted F antennas.

The ground plane 115 is provided on the cube 110. FIG. 3 shows that the length of the ground plane 115 is longer than the length L (see FIG. 2) of a part where the first radiation pattern 150a overlaps the substrate 120. However, it will be well understood that the length of the ground plane 115 may be freely set as long as it is longer than the length L (see FIG. 2) of the first radiation patch.

The first SMA connector 125a may be connected to the first metallic short-circuit plate 140a through the via hole 124a formed to pass through the substrate 120, the ground plane 115, and the cube 110. In addition, the second via hole (not shown) and the second SMA connector (not shown) would be provided on the opposite surface although not shown.

The via holes 126a and 128 may be formed to pass through the substrate 120. In addition, the first metallic short-circuit plate 140a and the third metallic short-circuit plate 160 may be connected to the ground plane 115 that is provided between the substrate 120 and the cube 110, through the via holes 126a and 128, respectively. Although not shown, a via hole (not shown) for connecting the second metallic short-circuit plate 140b (see FIG. 2) to the ground plane 115 would be provided on the opposite surface.

FIG. 4 is a cross-sectional view taken along line II-II′ of FIG. 1. The line II-II′ is a line for revealing the cross sectional view of the third metallic short-circuit plate 160.

Referring to FIG. 4, it may be seen that the ground plane is provided in an area where the first and second radiation patches 150a and 150b do not overlap the substrate 120. In addition, overlapping areas 117a and 117b under the substrate 120 may be filled with a dielectric substance having any permittivity. Although FIG. 4 shows that the widths of the overlapping areas 117a and 117b are wider than those W (see FIG. 2) of the radiation patches, it will be well understood that they may be freely set as long as they are wider than the widths W (see FIG. 2) of the radiation patches.

The first and second SMA connectors 125a and 125b may be connected to the first metallic short-circuit plate 140a through the via holes 124a and 124b formed to pass through the substrate 120, the ground plane 115, and the cube 110.

In addition, the via holes 126a, 126b and 128 may be formed to pass through the substrate 120. The first metallic short-circuit plate 140a to the third metallic short-circuit plate, 140a, 140b, and 160 may be connected to the ground plane 115 that is provided between the substrate 120 and the cube 110, through the via holes 126a, 126b, and 128, respectively.

According to an embodiment of the present invention, the ground plane 115 (see FIG. 3) is provided under the substrate 120 on which antennas are placed, excluding a part where the radiation patterns 150a and 150b overlap the substrate 120, so it is possible to obtain widened bandwidths of antennas. Also, by arranging the isolators 160 and 170 between the two inverted F antennas, it is possible to enhance the isolation between antennas. According to a micro antenna for a base station to which the antenna structure of the present invention is applied, it is possible to obtain a wide bandwidth, high isolation and gain even though it has a micro size.

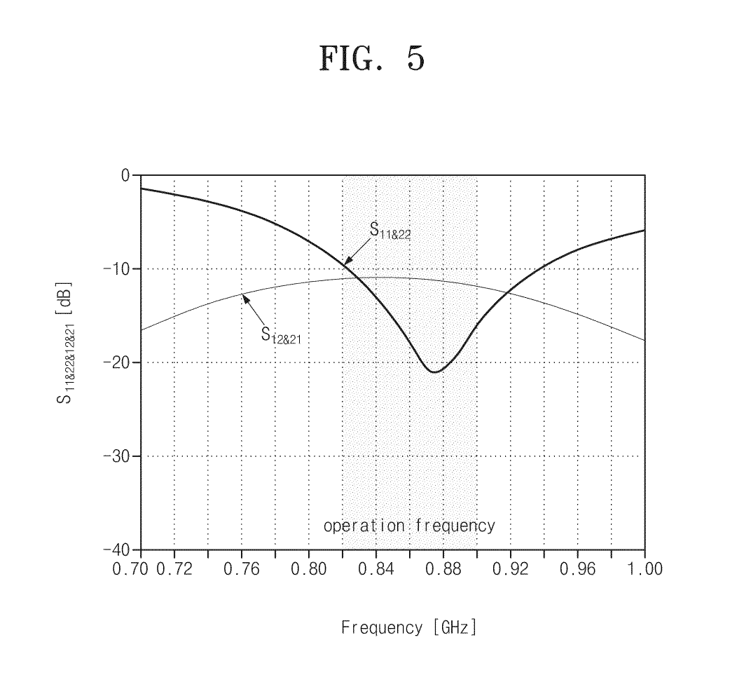

FIG. 5 is a graph showing a return loss and an isolation characteristic when there is no isolator 160 and 170 (see FIG. 1). As shown in FIG. 5, it may be seen that an operation frequency is approximately 0.82 GHz to 0.90 GHz and thus it is possible to widen a frequency band (a broadband characteristic), but an isolation value is approximately 10 dB and thus very poor. This means that leaky waves leaked from each of the inverted F antennas mutually affects and the performance of an antenna thus decreases.

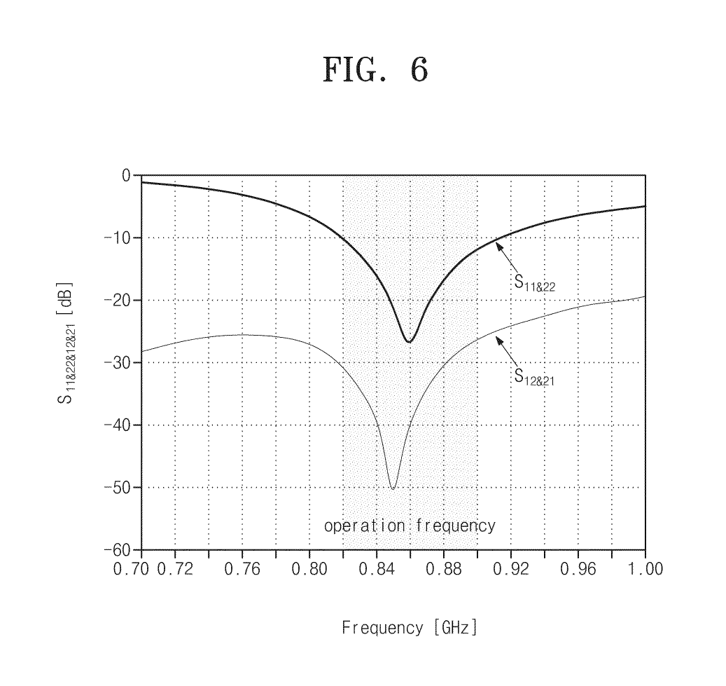

FIG. 6 is a graph showing a return loss and an isolation characteristic when there are isolators 160 and 170 (see FIG. 1). As shown in FIG. 6, it may be seen that the operation frequency is approximately 0.82 GHz to 0.90 GHz and a bandwidth increases (a broadband characteristic), as well as the isolation value is approximately −30 dB to −50 dB and thus very excellent. This means that there is no leaky wave leaked from each of the inverted F antennas and thus the performance of an antenna is enhanced.

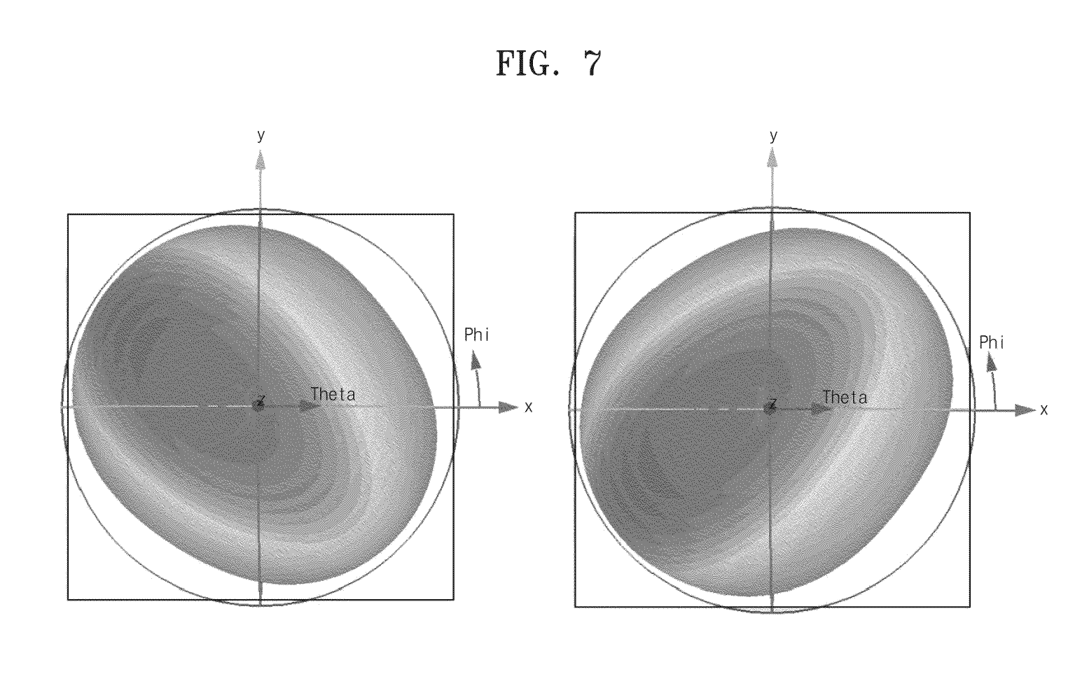

FIG. 7 is a graph showing the radiation pattern of a micro base station antenna according to an embodiment of the present invention. Referring to FIG. 7, each antenna may generate dual polarization that is orthogonally formed. The maximum gain of an antenna according to an embodiment of the present invention is equal to or higher than 3 dBi.

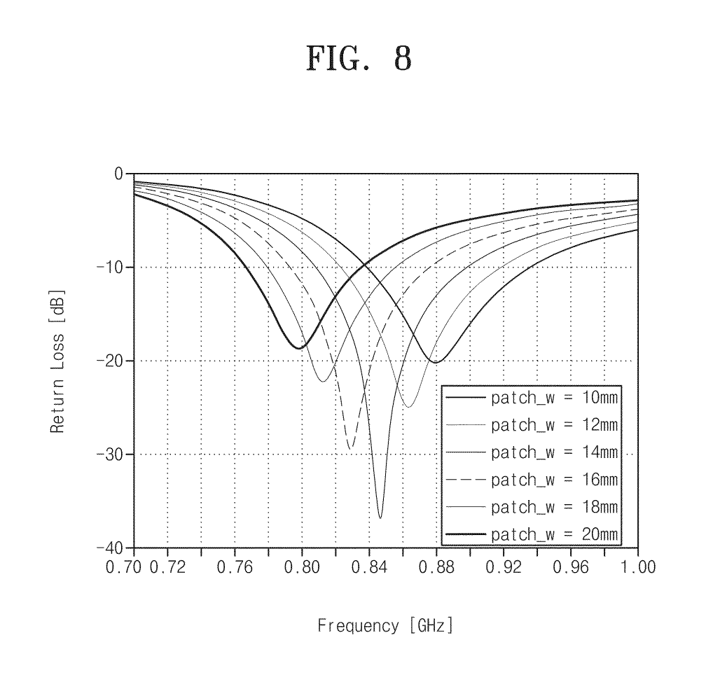

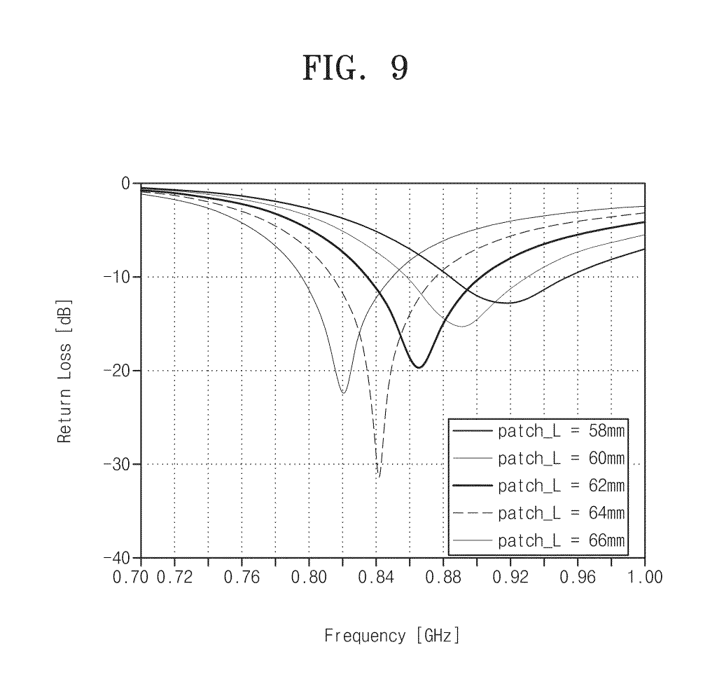

FIG. 8 is a graph showing a return loss depending on the width of a radiator in a micro base station antenna according to an embodiment of the present invention. It may be seen that the operation frequency decreases as the widths W (see FIG. 2) of the first and second radiation patches 150a and 150b becomes wider. In addition, it may be seen through the graph that the return loss decreases at approximately 0.82 GHz to 0.90 GHz and thus a broadband characteristic appears.

FIG. 9 is a graph showing a return loss depending on the length of a radiator in a micro base station antenna according to an embodiment of the present invention. It may be seen that the operation frequency decreases as the lengths L (see FIG. 2) of the first and second radiation patches 150a and 150b become longer. In addition, it may be seen through the graph that the return loss decreases to a value lower than or equal to approximately −20 dB at approximately 0.82 GHz to 0.90 GHz and thus a broadband characteristic appears.

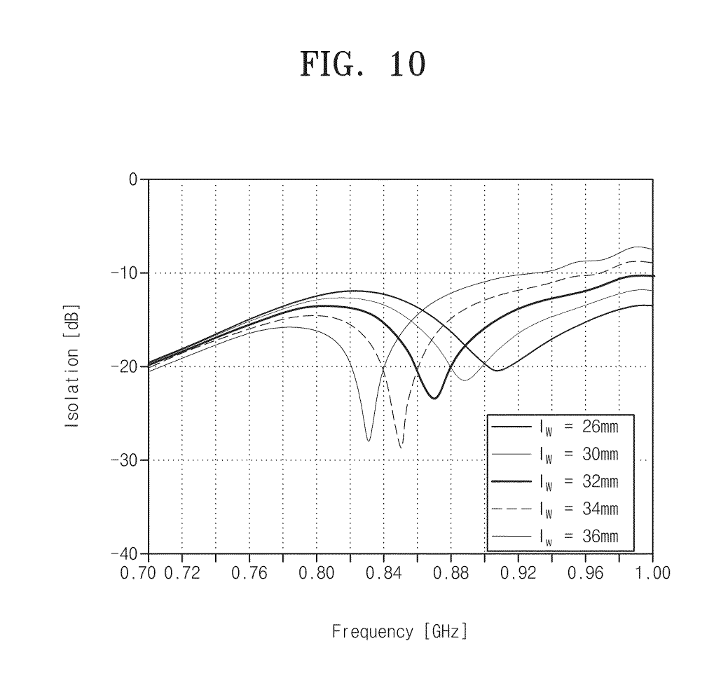

FIG. 10 is a graph showing an isolation characteristic depending on the width of a metallic isolating plate in a micro base station antenna according to an embodiment of the present invention. Referring to FIG. 10, the operation frequency decreases as the width I_{W} (see FIG. 2) of the metallic isolating plate becomes longer. In addition, it may be seen through the graph that the isolation decreases to a value lower than or equal to approximately −20 dB at approximately 0.82 GHz to 0.90 GHz and thus it is possible to obtain an excellent isolation characteristic.

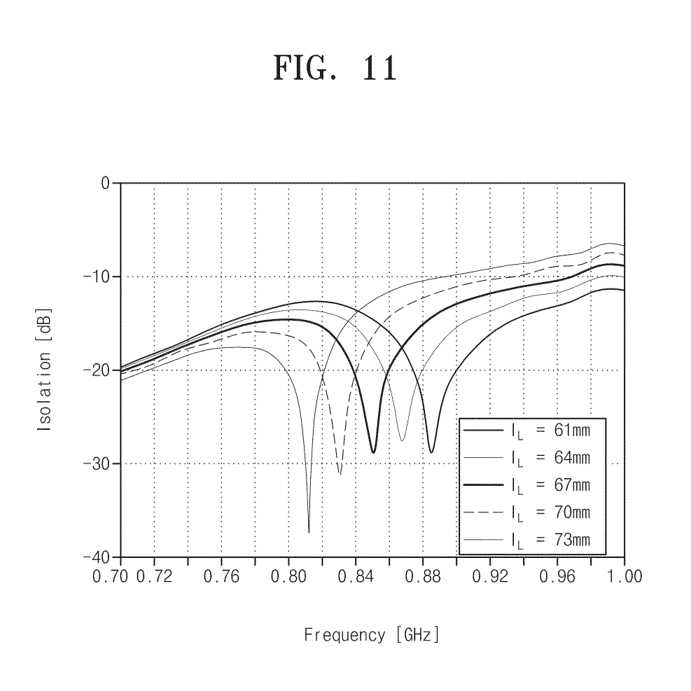

FIG. 11 is a graph showing an isolation characteristic depending on the length of a metallic isolating plate in a micro base station antenna according to an embodiment of the present invention. Likewise, it may be seen that as the length I_{L} (see FIG. 2) of the metallic isolating plate 170 becomes longer, the operation frequency decreases and it is possible to obtain an excellent isolation characteristic.

As a result, by adjusting the width and length W and L (see FIG. 2) of the first and second radiation patches 150a and 150b and the width and length I_{W} and I_{L} of the metallic isolating plate 170, it is possible to freely adjust the operation frequency and the bandwidth.

The micro base station antenna according to an embodiment of the present invention includes the first and second inverted F antennas. In addition, it is possible to enhance the isolation by providing the isolators 160 and 170 between the two inverted F antennas. Also, the ground plane 115 (see FIG. 3) is provided under the substrate 120 on which inverted F antennas are placed, excluding a part where the radiation patterns 150a and 150b overlap the substrate 120, so it is possible to obtain widened bandwidths of antennas. According to the micro base station antenna to which an inverted F antenna structure is applied according to an embodiment of the present invention, there is an advantage in that it is possible to obtain a wide bandwidth and a high gain and it is possible to enhance the isolation between antennas even though the antenna has a micro size.

It is obvious to a person skilled in the art that the structure of the present invention may be variously modified or changed without departing from the scope or technical spirit of the present invention. When considering the descriptions above, it is considered that the present invention includes changes and modifications of the present invention if they are within the scopes of the following claims and their equivalents.

What is claimed is:

1. A micro base station antenna comprising:
a substrate etched with first and second micro strip lines, the substrate being provided in a cube;
a first inverted F antenna including a first metallic short-circuit plate provided on the first micro strip line and a first radiation patch provided on the first metallic short-circuit plate;
a second inverted F antenna including a second metallic short-circuit plate provided on the second micro strip line and a second radiation patch provided on the second metallic short-circuit plate, the second inverted F antenna facing the first inverted F antenna; and
an isolator provided between the first inverted F antenna and the second inverted F antenna.

2. The micro base station antenna of claim 1, wherein the isolator comprises a third metallic short-circuit plate provided on the substrate and a metallic isolating plate provided on the third metallic short-circuit plate.

3. The micro base station antenna of claim 1, wherein the first and second micro strip lines comprise first and second power supply lines and first and second short-circuit lines, respectively.

4. The micro base station antenna of claim 3, further comprising a ground plane provided between the cube and the substrate,
wherein the ground plane is not provided on a part where the first and second radiation patches overlap the ground plane.

5. The micro base station antenna of claim 4, wherein the first and second power supply lines are connected to first and second SMA connectors respectively through via holes, wherein the via holes are formed by passing through the substrate, the ground plane, and the cube.

6. The micro base station antenna of claim 5, wherein the first and second short-circuit lines are connected to the ground plane through the via holes formed by passing through the substrate.

7. The micro base station antenna of claim 6, wherein the third short-circuit plate is connected to the ground plane through the via hole formed by passing through the substrate.

8. The micro base station antenna of claim 4, wherein the first and second radiation patches are quadrilateral or circular.

9. The micro base station antenna of claim 8, wherein the metallic isolating plate is quadrilateral or circular.

10. The micro base station antenna of claim 4, wherein the cube is a metallic component formed of aluminum Al or copper Cu.

11. The micro base station antenna of claim 4, wherein the cube is a non-metallic component formed of polycarbonate, acetal, Teflon, or silicon.

12. The micro base station antenna of claim 4, wherein one surface of the cube being in contact with the ground plane is a square, wherein one side of the square has a length smaller than or equal to half an operation frequency.
